(19) United States
(12) Patent Application Publication
(10) Pub. No.: US 2005/0060186 A1
(43) Pub. Date: Mar. 17, 2005

(54) Prioritized presentation of medical device events

(76) Inventors: Paul A. Blowers, St. Paul, MN (US); Joel R. Lauer, Rogers, MN (US); Christopher M. Manrodt, White Bear Lake, MN (US); Cheryl J. Protas, Ham Lake, MN (US); Seema Padmanabhan, Maple Grove, MN (US); William M. Sherman, Minneapolis, MN (US); James E. Willenbring, St. Paul, MN (US)

Correspondence Address: MEDTRONIC, INC., 710 MEDTRONIC PARKWAY NE, MS-LC340, MINNEAPOLIS, MN, 55432-5604, US

(21) Appl. No.: 10/650,497

(22) Filed: Aug. 28, 2003

(51) Int. Cl. G06F 17/60

(52) U.S. Cl. 705/2

(57) ABSTRACT

In general, the invention is directed to techniques for prioritized presentation of implantable medical device (IMD) events based on relative importance. Given a prioritization of events, the techniques permit presentation of events in an order or format that directs a clinician's attention to important events. In some embodiments, a clinician simultaneously views events obtained from multiple IMDs associated with multiple patients, e.g., via single user interface, and is aided by an order or format of presentation that reflects event prioritization. In some cases, an IMD event with a priority above a predetermined threshold triggers special actions. As one example, an event with a high relative importance may be presented using a conspicuous text format. As another example, an event with a priority above the threshold may trigger a notification to a clinician, or other persons.

### TECHNICAL FIELD

The invention relates to medical devices and, more particularly, to management of medical devices.

### BACKGROUND

An implantable medical device (IMD), such as a pacemaker, a defibrillator, a cardiac resynchronization therapy device, a drug delivery device, a neurostimulator, or the like, is typically used with a programmer, which sets operating parameters within the IMD to control therapy for a patient. The programmer communicates with the implantable medical device locally by telemetry, or remotely via a network. For remote communication, a local monitor is co-located with the patient to support wireless telemetry with the IMD. The local monitor relays interrogation data from the IMD to the remote programmer. Also, in some cases, the local monitor may relay programming instructions from the remote programmer to the IMD.

Interrogation data obtained from the IMD includes event data relating to therapy events and diagnostic events. A therapy event is administered by the IMD to the person carrying the IMD, and may include delivery of pacing pulses, cardioversion/defibrillation pulses, drugs, neurostimulation pulses, and the like. A diagnostic event relates to a physiological condition observed by the IMD, and includes sensed cardiac waveforms, respiratory waveforms, blood chemistry levels, or the like. IMD event data provides important information to a clinician. For example, the clinician may use the event data to determine if a new therapy is appropriate.

### SUMMARY

In general, the invention is directed to techniques for prioritized presentation of implantable medical device (IMD) events based on relative importance.

Given a prioritization of events, the techniques permit presentation of events in an order or format that directs a clinician's attention to important events. In some embodiments, a clinician simultaneously views events obtained from multiple IMDs associated with multiple patients, e.g., via single user interface, and is aided by an order or format of presentation that reflects event prioritization.

In some cases, an IMD event with a priority above a predetermined threshold triggers special actions. As one example, an event with a high relative importance may be presented using a conspicuous text format. As another example, an event with a priority above the threshold may trigger a notification to a clinician, or other caregivers.

In one embodiment, the invention is directed to a method including prioritizing events obtained from interrogation of a medical device implanted in a patient, wherein the events include therapy events and diagnostic events, and presenting a list of the events based on the prioritization.

In another embodiment, the invention is directed to a method including interrogating a medical device implanted in a patient, receiving event data, wherein the event data describes one of a therapy event and a diagnostic event, and assigning a relative importance to each of the events based on a level of priority for the event.

In an added embodiment, the invention is directed to a system comprising a prioritization engine to prioritize events obtained from interrogation of a medical device implanted in a patient, wherein the events include therapy events and diagnostic events, and a user interface device to present a list of the events based on the prioritization.

In a further embodiment, the invention is directed to a computer-readable medium containing instructions. The instructions cause a programmable processor to prioritize events obtained from interrogation of a medical device implanted in a patient, wherein the events include therapy events and diagnostic events, and present a list of the events based on the prioritization.

In another embodiment, the invention is directed to a computer-readable medium containing instructions that cause a programmable processor to interrogate a medical device implanted in a patient, receive event data, wherein the event data describes one of a therapy event and a diagnostic event, and assign relative importance to each event.

The details of one or more embodiments of the invention are set forth in the accompanying drawings and the description below. Other features and aspects of the invention will be apparent from the description and drawings, and from the claims.

### BRIEF DESCRIPTION OF DRAWINGS

FIG. 1 is a block diagram illustrating an exemplary system for prioritizing therapy and diagnostic events obtained from an IMD based on relative importance.

FIG. 2 is a block diagram of the system of FIG. 1, illustrating further details of a prioritization engine for prioritizing events based on relative importance.

FIG. 3 is a block diagram illustrating an alternative system for prioritizing events based on relative importance.

FIG. 4 is a screenshot illustrating an exemplary user interface that presents prioritized events.

FIG. 5 is a flow chart illustrating an exemplary technique for prioritizing events based on relative importance.

FIG. 6 is a flow chart illustrating an exemplary technique for prioritizing events based on relative importance.

### DETAILED DESCRIPTION

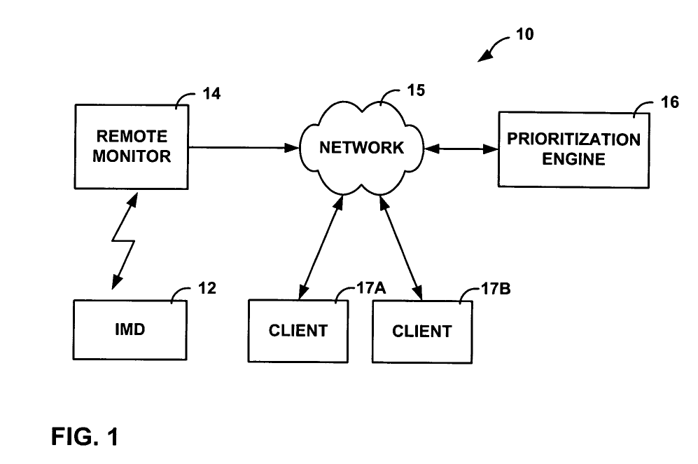

FIG. 1 is a block diagram illustrating an exemplary system 10 for prioritizing therapy and diagnostic events obtained from an IMD based on relative importance. As shown in FIG. 1, system 10 includes an IMD 12, a remote monitor 14, a network 15, a prioritization engine 16, and one or more clients 17A and 17B (collectively “clients 17”). IMD 12 may comprise a pacemaker, a defibrillator, a cardiac resynchronization therapy device, a drug delivery device, a neurostimulator, or the like. Monitor 14 interrogates IMD 12 to obtain event data, including therapy event data and diagnostic event data. Monitor 14 communicates the events to prioritization engine 16 via network 15.

Prioritization engine 16 prioritizes the events in terms of relative importance and serves the events to clients 17 connected to network 15. In the example of FIG. 1, system 10 includes two clients, 17A and 17B, but there may be any number of clients coupled to network 15.

Each client 17 may be used by a clinician, a patient carrying IMD 12, a friend or family member associated with the patient, or the like. In each case, client 17 includes a web browser or other viewing application that renders prioritized event data obtained from prioritization engine 16 for presentation to a person. Accordingly, in some embodiments, prioritization engine 16 includes a web server to serve event data to clients 17. In the case of a clinician, clients 17 may present event data for multiple IMDs 12 and multiple patients.

Prioritization engine 16 requests interrogation of IMD 12 via network 15 and remote monitor 14. In addition, prioritization engine 16 monitors network 15 for a response to the interrogation request. The response to the interrogation request comprises a one or more IMD events that have occurred since a previous interrogation. Prioritization engine 16 prioritizes the interrogation events based on relative importance. Prioritization engine 16 serves a prioritized list of events in response to requests from clients 17. Client 17 renders a prioritized presentation of the events for viewing by a user. Prioritization engine 16 includes appropriate security and authentication measures to ensure that particular event data is only accessible by authorized clients 17.

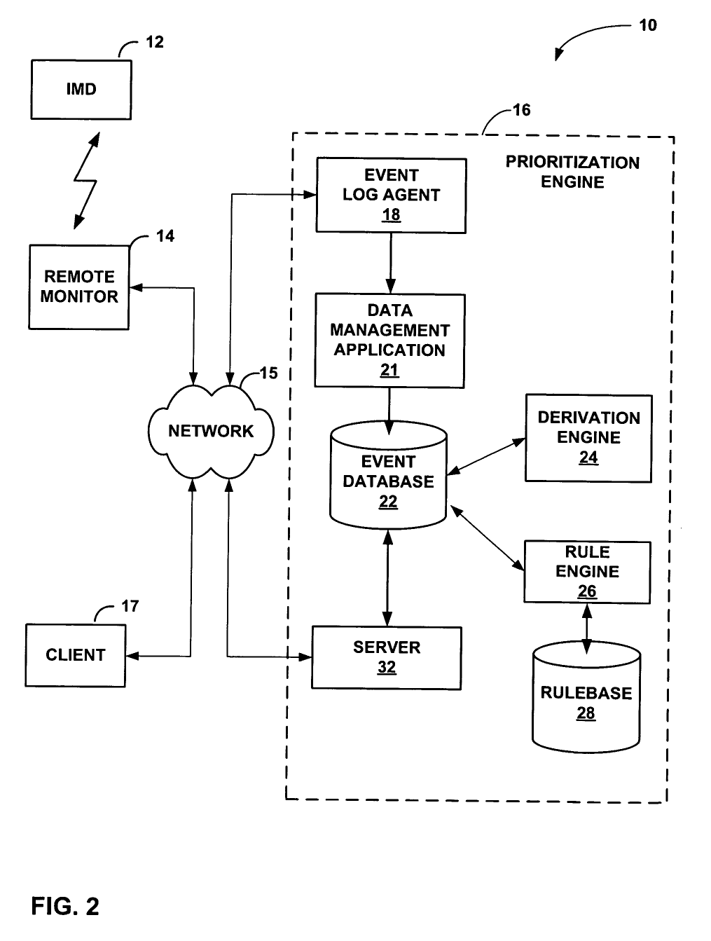

FIG. 2 is a block diagram of system 10 of FIG. 1, illustrating prioritization engine 16 in further detail. In the example of FIG. 2, prioritization engine 16 includes an event log agent 18, a data management application 21, an event database 22, a derivation engine 24, a rule engine 26, a rule database 28, and a server 32. Prioritization engine 16, including event log agent 18, data management application 21, derivation engine 24 and server 32, may be realized by one or more software processes running on different or common processors. Event log agent 18 requests an interrogation session with IMD 12 via network 15A and remote monitor 14.

Event log agent 18 monitors network 15 for a response to the interrogation request. A device, such as remote monitor 14, responds to the interrogation request by interrogating IMD 12, and obtaining raw event data including therapy events, diagnostic events, or both, from IMD 12. Monitor 14 then communicates the raw event data to prioritization engine 16 via network 15. Event log agent 18 buffers the incoming raw data, and send at least a portion of the raw data to a data management application 21, which parses the raw data into event data. Data management application 21 populates database fields within an event database 22 with the event data.

In some embodiments, derivation engine 24 is provided to process event data from selected fields within event database 22, and derive additional event data. For example, derivation engine 24 analyzes the event data, derives additional database queries, and creates additional database entries based on the results of the queries. For example, if it is evident that a fibrillation event occurred based on the event data, derivation engine 24 may query event database 22 for more information about events occurring before, after, or during the fibrillation episode, including therapy events and diagnostic events.

In this manner, derivation engine 24 obtains from event database 22 additional information of clinical importance, such as the duration of the fibrillation, defibrillation energy information, defibrillation results, therapy delivered prior to defibrillation, whether anti-tachycardia pacing (ATP) was enabled or disabled, and so forth. Derivation engine 24 assembles the information and generates additional events for addition to event database 22.

Rule engine 26 evaluates event data stored in event database 22 using rules stored in rulebase 28 to prioritize the events in terms of relative importance. Rulebase 28 assigns relative priorities to different types of events based on clinical importance. For example, a defibrillation event ordinarily will have a higher priority than an arrhythmia event. Likewise, a low battery or lead failure event will have higher priority than an event indicating delivery of ATP. The particular rules and priorities reflected in the contents of rulebase 28 may vary, and may reflect individual desires of particular device companies, health care institutions, or even particular clinicians. Accordingly, the invention is not limited to any particular set of rules for prioritization.

Rule engine 26 uses the rules from rulebase 28 to prioritize the events. For example, rule engine 26 compares an event to a series of rules and identifies instance in which the comparison returns a “true” result. In one embodiment, rule engine 26 flags events with numbers, letters, formats, tags, or other indications of rank.

For example, if an event field for a corresponding event, such as the occurrence of a defibrillation, is set to true, a high ranking is associated with the event. Events are prioritized based on the relative importance assigned to them by rule engine 26. In some cases, an event may be “true” for multiple rules. In this case, rule engine 26 can be configured to produce a priority based on cumulative results for multiple rules.

In some embodiments, prioritization engine specifies an event with a high priority as warranting a “special action” to occur. The special action may include using conspicuous ordering, text or formatting in presentation of the event data. Alternatively, the special action may include generating a notification to the clinician, the patient, a patient family member or guardian.

The notification may be an audible or visible alarm, an email or instant message, a pager alert, a fax, a special text message within the event data presentation, or the like. For example, event data corresponding to an event with a ranking above a predetermined threshold may be presented using bold, colored, capitalized, or italicized text, or presented in an ordered list that presents higher priority events first.

In one embodiment, server 32 serves HTML or XML code including prioritized event data from event database 22. Client 17 renders the HTML code to generate a presentation of the prioritized event data, and other information, within a web browser or other viewing application. Server 32 connects to network 15, which may be a LAN, an intranet, the Internet, or the like. Client 17, which is connected to network 15, accesses web pages served by server 32 to acquire the prioritized event data. In some embodiments, a clinician or patient views prioritized event data for a single patient using a web browser. In other embodiments, a clinician views prioritized event data for multiple patients, e.g., via a single user interface.

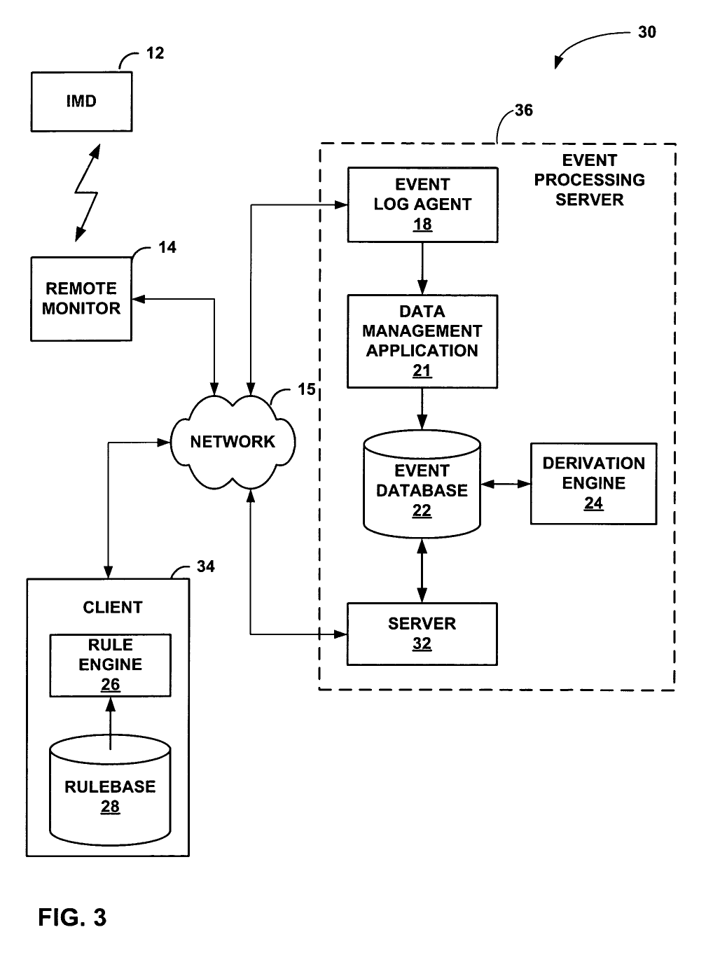

FIG. 3 is a block diagram illustrating an alternative system 30 for prioritizing events based on relative importance. System 30 corresponds to system 10 of FIG. 2, but assigns the event prioritization functionality to a client 34. Like system 10, system 30 includes an IMD 12, a remote monitor 14, a network 15, and a client 34. However, system 30 includes an event processing server 36.

Instead of placing a prioritization engine within the event processing server, the prioritization engine is placed within client 34. In the example of FIG. 3, event processing server 36 includes an event log agent 18, a data management application 21, an event database 22, a derivation engine 24, and a server 32, each of which functions substantially as described with reference to system 10 of FIG. 2.

As in the example of FIG. 2, event log agent 18 requests event data from monitor 14 via network 17, and monitors network 15 for a response. In addition, data management application 21 populates database fields within event database 22 with the event data received by event log agent 18. Derivation engine 24 derives additional event data from the event data in event database 22.

However, responsibility for prioritization of the event data resides not within event processor server 36, but within individual clients 17. In other words, each client 17 is configured to prioritize event data transmitted by server 32. The event data may be embedded in HTML or XML code transmitted by server 32.

As shown in FIG. 3, after client 34 obtains the event data, it passes the event data to rule engine 26, which uses rules from rulebase 28 to prioritize the events in a manner similar to that described with reference to FIG. 2. Client 34 then renders the prioritized event data to present a prioritized presentation of the events to a person associated with the client. In general, the embodiment illustrated in FIG. 2 makes use of centralized, server-oriented event prioritization, whereas the embodiment illustrated in FIG. 3 makes use of a distributed, client-oriented event prioritization.

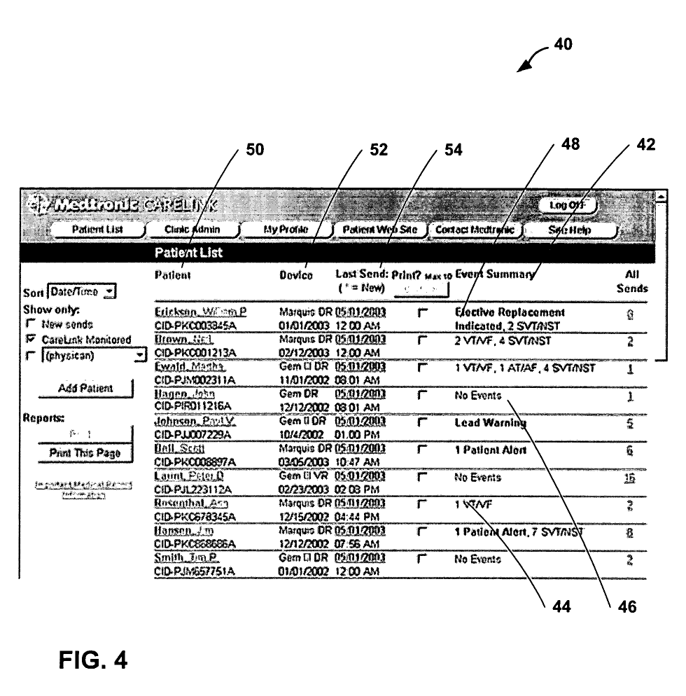

FIG. 4 is a screenshot illustrating an exemplary user interface 40 presented by client 17 of FIG. 2 or client 34 of FIG. 3. User interface 40 includes event information for multiple patients. The event information is assembled from numerous interrogation sessions between event log agent 18 and remote monitors 14 associated with different patients and IMDs 12. Presentation of event information for multiple patients permits a clinician to view information for many different patients at once, via single user interface 40. In accordance with the invention, user interface 40 presents a prioritized list of events based on relative importance.

Again, the prioritization may be represented by event order, format, text, or the like. In the example of FIG. 4, user interface 40 is divided into several columns, with each patient associated with an entry in each column. The columns shown in FIG. 4 include patient information 50, device information 52, information about a last send 54, i.e., a previous interrogation cycle, and event summary information 42.

Device information 52 describes the particular IMD 12 associated with a patient described by patient information 50. Information about the last time an IMD 12 sent event data to a database associated with interface 40 is presented in information about a last send 54. Event summary information 42 is filled with prioritized lists of IMD events for individual patients.

The lists of IMD events may comprise a regular text entry 44, a “No Event” text entry 46, a conspicuously bolded text entry 48, or the like. Accordingly, the list may not be ordered. On the contrary, in some embodiments, a higher priority event may appear later in the list, but be identified by a particular text, font or style convention. In other embodiments, however, the highest priority event may be presented first in the list, followed by list of additional events in descending order of priority.

As shown in FIG. 4, an example of regular text entry 44 is “1 VT/VF”, which may signify the number of ventricular tachycardia/ventricular fibrillation (VT/VF) episodes that have occurred in a certain period of time. An example bolded text entry 48 is “Elective Replacement Indicated”, which corresponds to patient William Erickson. As shown in FIG. 4, event summary 42 for William Erickson also includes a non-bolded text entry “2 SVT/NST” having lower priority than the IMD event, “Elective Replacement Indicated,” which is listed first in the event summary for William Erickson.

The text entry, “2 SVT/NST,” may signify the number of VT/VF episodes that have occurred in a certain period of time. In one embodiment, a prioritized IMD event may be bolded to indicate that it is a high priority event that demands attention. A “No Event” text entry, such as “No Event” text entry 46, means that no IMD event occurred to a corresponding patient, such as Peter Launt, that ranked high enough to be included in event summary information 42.

User interface 40 provides an example of an interface for presenting information for multiple patients while prioritizing IMD events associated with an individual patient based on levels of relative importance. The organization of the interface shown in FIG. 4 can take a variety of forms while still including information about prioritized IMD events for individual patients. In addition, in some embodiments, information from only one patient may be presented at a time.

In exemplary user interface 40, higher priority events are identified in bold text. Other possibilities for conspicuous identification of higher priority events may include capitalizing, italicizing, underlining, highlighting, use of colored text, display of special text or graphics that identify a particular event, or combinations thereof. In general, prioritized presentation of event data can aid a person in quickly identifying more important or interesting data about a patient or IMD. For a clinician, prioritized presentation of event data can significantly improve workflow, and possibly increase patient safety and care by promoting prompt discovery and follow-up for important events.

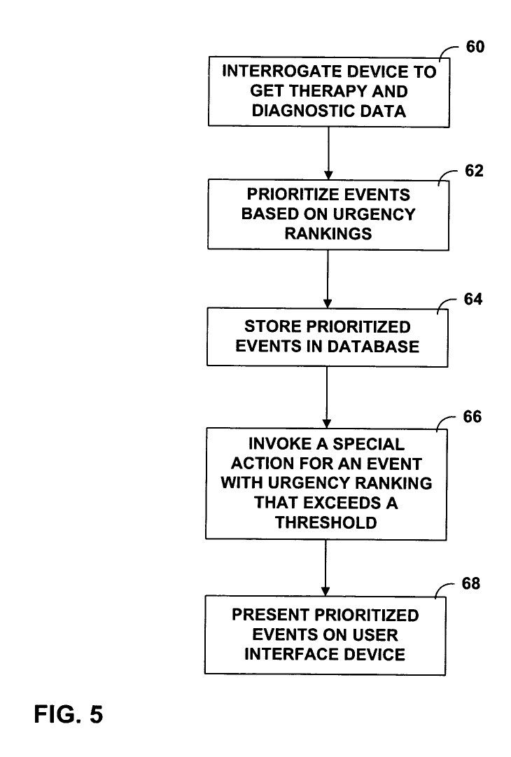

FIG. 5 is a flow chart illustrating an exemplary technique for prioritizing events based on levels of relative importance. In one embodiment, an IMD) is interrogated to receive event data, such as therapy data and diagnostic data, from IMD 12 (60). The events described by the event data are prioritized based on relative importance assigned to each event (62), e.g., by consultation with rules within a rulebase. A list of the prioritized events are stored in a database (62). In one embodiment, a special action is invoked to address an event with a relative importance that exceeds a threshold (66). The list of the prioritized events are presented on a user interface device (68), such as a computer display.

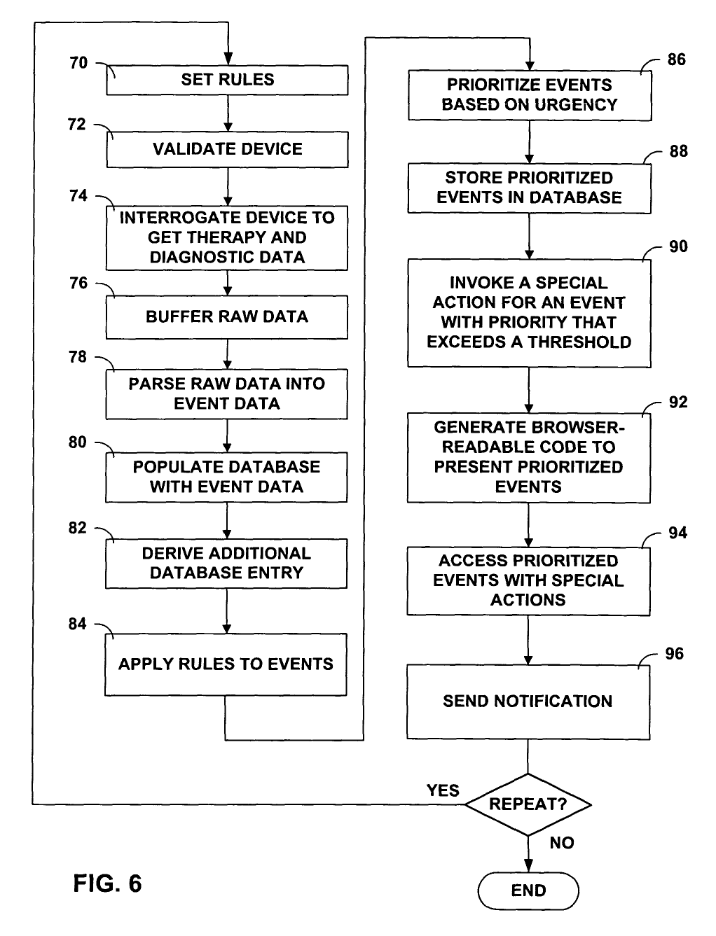

FIG. 6 is a flow chart illustrating another exemplary technique for prioritizing events based on levels of relative importance. In one embodiment, a collection of rules are developed (70) to establish relative priorities among different events. In particular, the rules may be stored in a rulebase, which is accessed by a rule engine, as described herein. In one embodiment, the rule engine receives a list of unprioritized events from an event database. The rule engine assigns priorities to events based on the rules in the rulebase.

In one embodiment, event log agent 18 requests an interrogation session with IMD 12 via network 15 and remote monitor 14. Event log agent 18 further monitors network 15 for a response to the interrogation request. A device, such as remote monitor 14, responds to the interrogation request by sending validation information that verifies information such as IMD information, patient information, clinic information, location, and the like.

Once the device is validated (72), raw data describing therapy and diagnostic events are obtained from IMD 12 to monitor 14, and then sent to event log agent 18 (74). In one embodiment, event log agent 18 buffers the incoming raw data (76), and sends at least a portion of the raw data to data management application 21, which may parses the raw data to generate event data for storage in event database 22 (78). Specifically, data management application 21 populates database fields within event database 22 with the event data.

In some embodiments, derivation engine 24 receives data from selected fields within event database 22, and derives a additional event data (82). In particular, derivation engine 24 may analyze the event data, derive an additional query, and create an additional database entry based on the result of the query.

Rule engine 26 prioritizes the events from event database 22. In particular, rule engine 26 applies rules from rulebase 28 (84), and then prioritizes the events based on the results (86). The prioritized events are then stored in event database 22 (88).

In one embodiment, an event may cause a “special action” to be invoked (90) if the event has a priority that exceeds a threshold (90). The special action may include using conspicuous text when presenting data from the event, generating an alarm, a perceptible signal, notifying a clinician, notifying a patient, notifying an acquaintance of the patient, presenting a special text message, or the like.

In one embodiment, server 32 accesses event database 22 and obtains event data. Server 32 generates browser-readable code (92) that allows client 17 to access prioritized events (94) via network 15. Special actions may be encoded within the prioritized event data for issuance of a notification. For example, server 32 or client 17 may send a notification based on an event with an elevated priority (96). Again, the notification may be an audible or visible alarm, an email or instant message, a pager alert, presenting a special text message within the event data presentation, or the like.

The techniques described herein may be partially or wholly executed in software. In that case, a computer readable medium may store or otherwise comprise computer-readable instructions, i.e., program code that can be executed by a processor to carry out one of more of the techniques described above. For example, the computer readable medium may comprise random access memory (RAM), read-only memory (ROM), non-volatile random access memory (NVRAM), electrically erasable programmable read-only memory (EEPROM), flash memory, magnetic or optical media, or the like.

Various embodiments of the invention have been described. These and other embodiments are within the scope of the following claims.

1. A method comprising:
prioritizing events obtained from interrogation of a medical device implanted in a patient, wherein the events include therapy events and diagnostic events; and
presenting a list of the events based on the prioritization.

2. The method of claim 1, further comprising:
prioritizing events obtained from a plurality of medical devices implanted in different patients; and
presenting a list of the patients and a list of the events for each of the patients based on the prioritization.

3. The method of claim 1, wherein prioritizing events includes prioritizing the events based on a relative importance associated with the events.

4. The method of claim 1, further comprising invoking a special action in response to an event with a relative importance that exceeds a threshold.

5. The method of claim 4, wherein the special action comprises using a conspicuous text format when presenting data from the event.

6. The method of claim 5, wherein the conspicuous text format includes one of font, bold text, highlighted text, underlined text, and italicized text.

7. The method of claim 4, wherein the special action includes generating an alarm, notifying a clinician, and notifying a patient.

8. A method comprising:
interrogating a medical device implanted in a patient;
receiving event data, wherein the event data describes one of a therapy event and a diagnostic event;
assigning a relative importance to each of the events.

9. The method of claim 8, further comprising prioritizing events obtained from the interrogation based on the relative importance.

10. The method of claim 8, further comprising assigning the relative importance based on a set of rules.

11. The method of claim 8, further comprising presenting a prioritized list of the events based on the relative importance.

12. The method of claim 8, further comprising:
prioritizing events obtained from a plurality of medical devices implanted in different patients; and
presenting a list of the patients and a prioritized list of the events for each of the patients based on the relative importance.

13. The method of claim 8, further comprising invoking a special action in response to an event with an relative importance that exceeds a threshold.

14. The method of claim 13, wherein the special action comprises using a conspicuous text format when presenting data from the event.

15. The method of claim 14, wherein the conspicuous text format includes one of bold text, highlighted text, underlined text, and italicized text.

16. The method of claim 13, wherein the special action includes generating an alarm, notifying a clinician, and notifying a patient.

17. A system comprising:
a prioritization engine to prioritize events obtained from interrogation of a medical device implanted in a patient, wherein the events include therapy events and diagnostic events; and
a user interface device to present a list of the events based on the prioritization.

18. The system of claim 17, further comprising a data management application that parses raw data from the implantable medical device, and populates fields of a database with event data.

19. The system of claim 18, wherein the event data comprises one of patient name, device type, date event data was parsed, and event type.

20. The system of claim 17, further comprising a database to store the prioritized events, wherein the user interface device includes a web browser to access the prioritized events via a network connection.

21. The system of claim 20, further comprising a derivation engine to generate additional events based on the stored events.

22. The system of claim 17, further comprising a rule engine to assign relative importance to the events based on rules from a rule database.

23. The system of claim 17, wherein the prioritization engine prioritizes events obtained from a plurality of medical devices implanted in different patients, and the user interface presents a list of the patients and a list of the events for each of the patients based on the prioritization.

24. The system of claim 17, wherein the prioritization engine prioritizes the events based on a relative importance associated with the events.

25. The system of claim 17, further comprising a notification device to perform a special action in response to an event with relative importance that exceeds a threshold, wherein the relative importance is assigned to the event based on a level of priority for the event.

26. The system of claim 25, wherein the special action comprises one of using a conspicuous text format when presenting data from the event.

27. The system of claim 26, wherein the conspicuous text format includes one of bold text, highlighted text, underlined text, and italicized text.

28. The system of claim 25, wherein the special action includes generating an alarm, notifying a clinician, and notifying a patient.

29. A computer-readable medium comprising instructions for causing a programmable processor to:
prioritize events obtained from interrogation of a medical device implanted in a patient, wherein the events include therapy events and diagnostic events; and
present a list of the events based on the prioritization.

30. The computer-readable medium of claim 29, wherein the instructions cause the processor to:
prioritize events obtained from a plurality of medical devices implanted in different patients; and
present a list of the patients and a list of the events for each of the patients based on the prioritization.

31. The computer-readable medium of claim 29, wherein the instructions cause the processor to prioritize events based on a relative importance associated with the events.

32. The computer-readable medium of claim 29, wherein the instructions cause the processor to invoke a special action in response to an event with relative importance that exceeds a threshold.

33. A computer-readable medium comprising instructions for causing a programmable processor to:
interrogate a medical device implanted in a patient;
receive event data, wherein the event data describes one of a therapy event and a diagnostic event; and
assign a relative importance to each event.

34. The computer-readable medium of claim 33, wherein the instructions cause the processor to prioritize events obtained from interrogation based on relative importance.

35. The computer-readable medium of claim 33, wherein the instructions cause the processor to assign the relative importance based on a set of rules.

36. The computer-readable medium of claim 33, wherein the instructions cause the processor to present a list of the events based on the prioritization.

37. The computer-readable medium of claim 33, wherein the instructions cause the processor to:
prioritize events obtained from a plurality of medical devices implanted in different patients; and
present a list of the patients and a prioritized list of the events for each of the patients based on relative importance.

38. The computer-readable medium of claim 33, wherein the instructions cause the processor to invoke a special action in response to an event with a relative importance that exceeds a threshold, wherein the relative importance is assigned to the event based on a level of priority for the event.

39. A device comprising:
a prioritization engine to prioritize events obtained from interrogation of a medical device implanted in a patient, wherein the events include therapy events and diagnostic events; and
a database to store the prioritized events.

40. The system of claim 39, further comprising a data management application that parses raw data from the implantable medical device, and populates fields of the database with event data.

41. The system of claim 39, wherein the event data comprises one of patient name, device type, date event data was parsed, and event type.

42. The system of claim 39, further comprising a derivation engine to generate additional events based on the stored events.

43. The system of claim 39, further comprising a rule engine to assign relative importance to the events based on rules from a rule database, wherein the prioritization engine prioritizes the events based on the relative importance.

44. The system of claim 17, wherein the prioritization engine prioritizes events obtained from a plurality of medical devices implanted in different patients.
